(19) United States
(12) Patent Application Publication
(10) Pub. No.: US 2002/0146944 A1
(43) Pub. Date: Oct. 10, 2002

(54) Terminal for electrical connector and terminal material with a carrier

(76) Inventor: Toshimoto Akiyama, Tokyo (JP)

Correspondence Address: KANESAKA & TAKEUCHI, 1423 Powhatan Street, Alexandria, VA, 22314, US

(21) Appl. No.: 10/102,893

(22) Filed: Mar. 22, 2002

(30) Foreign Application Priority Data
Apr. 4, 2001 (JP) 2001-105584

(51) Int. Cl. H01R 4/48

(52) U.S. Cl. 439/862

(57) ABSTRACT

A terminal is made by stamping and then bending a metal sheet. It has a plurality of contact blades (11, 12; 15) which extend in the same direction, join at their ends (11A, 12A; 15A) so as to be one metal sheet, and have the same length in the extending direction.

### BACKGROUND OF THE INVENTION

1. Field of the Invention

The present invention relates to terminals for electrical connectors and terminal material with a carrier.

2. Description of the Related Art

It is known to make a terminal with a plurality of contact blades by stamping and bending a metal sheet.

In FIG. 4(A), a terminal of this type has a first and a second contact blades 51 and 52 which are joined at their base 53, and is made by stamping and then bending a metal sheet. The first and the second contact blades 51 and 52 extend from the base 53, being parallel to x-axis. The first contact blade 51 is formed as a contact piece which maintains its flat surface, while the second contact blade 52 is bent at its in-between section 52A and its end section 52B against the metal sheet surface. The contact blades made in this way, 51 and 52, have almost same length in x-axis direction, as shown in FIG. 4(A).

To make the terminal described above, first stamp a long metal strap to make an unfinished terminal, where a number of aforementioned two contact blades 51 and 52 before bending process are joined via carrier (narrow strip) 54 with certain intervals, as shown in FIG. 4(B), then bend the first contact blade 51 by turning upward around x-axis, and thereafter bend the second contact blade 52 at the in-between section 52A and the end section 52B around y-axis, so as to be formed as illustrated in FIG. 4(A). To put the terminal into a connector, disjoin the terminal from the carrier by cutting at its base so as to be an independent terminal.

In the terminal obtained in this way, the contact blades 51 and 52 have same length (dimension in x-direction), but as for the terminal material with carrier as shown in FIG. 4(B), which is the terminal before bending process, the second contact blade 52 is much longer than the first contact blade 51.

To prepare the terminal material with a carrier before bending process as in FIG. 4(B), the original metal strap is required to have a width which is at least equivalent to a distance between the carrier 54 and the end of the longer contact blade 52. Therefore, to stamp the terminal material with the carrier of FIG. 4(B) from a metal strap, there is a lot of waste of the metal sheet due to the large difference between lengths of the contact blades 51 and 52. Therefore, the yield of the material is not satisfactory.

### SUMMARY OF THE INVENTION

Accordingly, it is an object of the invention to provide a terminal and a terminal material with a carrier capable of providing a high yield of material.

The terminal for an electrical connector of present invention is made by stamping and then bending a metal sheet, and has a plurality of contact blades which extend in the same direction when it is stamped. In a terminal for an electrical connector of the present invention, a plurality of contact blades are joined at their bases so as to be one metal sheet, and extend in the same direction with the same length when the terminal is stamped.

According to a terminal like this, since all the contact blades have approximately the same length, an original metal sheet, such as the metal strap, does not have to be wasted in stamping process; therefore the yields are improved. At least one contact blade is an elastic contact piece, and can elastically deform to a direction perpendicular to the extending direction of the other contact blades.

Also, when at least one of the contact blades needs to be rigid, the contact blade can be pin-shaped with its rounded end folded in a direction perpendicular to the extending direction. Moreover, at least one of the contact blades has a connection section to connect with another terminal at its base facing to a different direction from the contact blade, whereby enabling complicated connection and combination with other terminals.

Furthermore, the plurality of contact blades form elastic contact pieces, and at least one of the contact blades can be designed to elastically deform in perpendicular direction to the other contact blades, making it possible to diversify directions of elasticity of the contact blade.

The terminals described above can be obtained in the form of a terminal material with a carrier, wherein the plurality of terminals are joined at their bases to an edge of the strip-shaped carrier with certain intervals, and the contact blades extend at right angles to the edge.

### BRIEF DESCRIPTION OF THE DRAWINGS

FIG. 1(A) is a side view of a terminal according to the first embodiment of the invention;

FIG. 1(B) is a front view of the terminal;

FIG. 1(C) is a plan view of the terminal material with the carrier;

FIG. 2(A) is a perspective view of a terminal according to the second embodiment of the invention;

FIG. 2(B) is a plan view of the terminal material with carrier;

FIG. 3 is a perspective view of the terminal of FIG. 2 when it is used with another terminal or contact blade;

FIG. 4 is a perspective view, partially cutout, of an electrical connector with the terminal inserted into a housing;

FIG. 5(A) is a perspective view of a conventional terminal; and

FIG. 5(B) is a plan view of the terminal material with the carrier.

### DESCRIPTION OF THE PREFERRED EMBODIMENTS

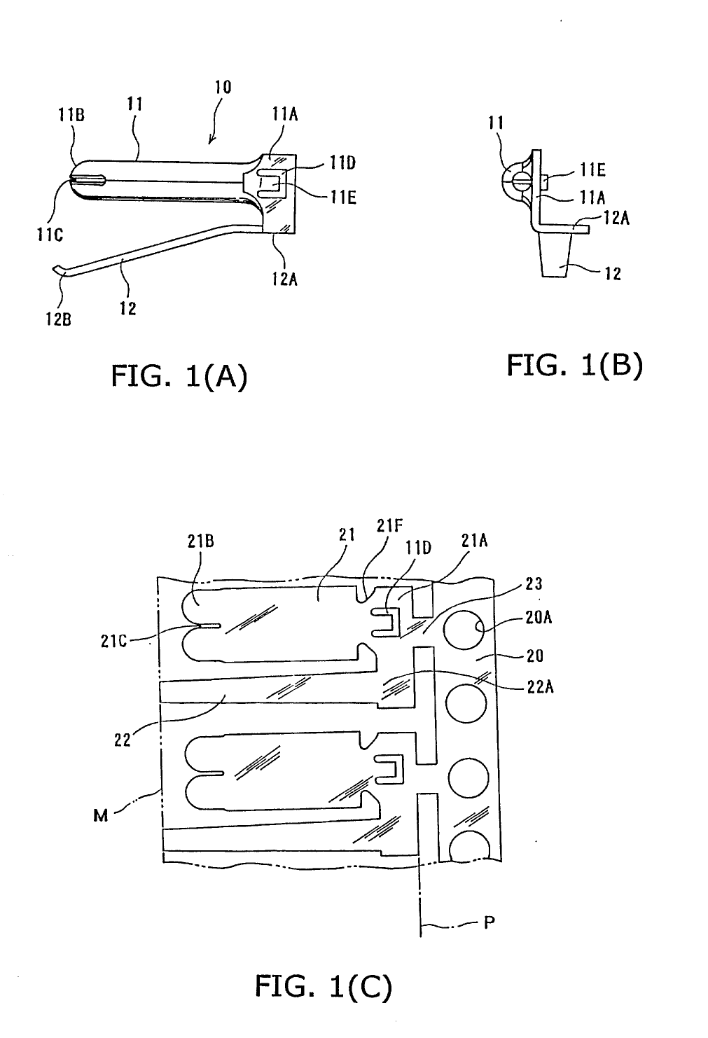

Embodiments of the present invention will now be described with reference to the accompanying drawings, FIGS. 1 through 3.

First Embodiment

In FIGS. 1(A) and (B), a terminal 10 of the present invention has a first contact blade 11 which is pin-shaped and highly rigid, and a second contact blade 12 which is an elastic piece, together. The terminal 10 is made by stamping and then bending a metal strap, and the first and the second contact blades 11 and 12 are joined at their bases 11A and 12A, which are angled to be L-shaped, as shown in FIG. 1(B).

The first contact blade 11 extends leftward from its base 11A, and rounded around its extending axis direction so as to be shaped like a pin. The end 11B of the contact blade 11 is a spherical and has a slit 11C so as to gain elasticity at the end 11B in its radius direction. Also, a flat base 11A has a staple-shaped groove 11D made by stamping process, and the groove 11D forms a lance 11E which shapes like a tongue piece. The lance 11E is formed so as to incline to a thickness direction of the metal sheet, and designed to prevent the terminal from sliding out by engaging between the end of the lance 11E and corresponding engaging section of a housing 30 when the terminal 10 is inserted into the housing 30 to assemble.

The second contact blade 12 shapes like a narrow strip, and extends in the same direction, leftward in FIG. 1(A), with the same length as the first contact blade, and inclines downward. The end of the second contact blade forms a contact section 12B which is curved by bending process. In FIG. 1(A), the second contact blade 12 can elastically deflect upward at the contact section 12B by upward contact pressure at a time of contacting with a substrate.

The terminal of the present invention is made from a metal strap as illustrated in FIG. 1(C), according to the following procedures.

First, prepare an elongated metal strap M, as shown by double-dotted dash line in FIG. 1(C). Then, stamp the metal strap to make an unfinished terminal or a terminal material with a carrier as illustrated by solid line in the an exploded view. Here, the unfinished terminal has a carrier 20, a first plate section 21 and a second plate section 22. The carrier 20 extends along a side of the metal strap M, and has engaging holes with certain intervals for feeding.

The first plate section 21 has the same length as the first contact blade 11 and the same width as the expanded width of the first contact blade 11. The first plate section 21 has a round bottom notch 21F at each edge of a section 21A which corresponds to a base 11A in FIG. 1(A), and a groove 11D at its substantially central area. Also, the first plate section 21 has two semicircular sections 21B at its left end, having a slit 21C between the circular sections.

The second plate section 22 extends in the same direction as the first plate section from a section 22A which corresponds to the base 12A in FIG. 1(A), has the same length as the second contact blade in the extending direction, and is slightly tapered towards its end. Therefore, the second plate section 22 has approximately the same length as the first plate section 21. Here, “approximately the same length” means that the first plate section 21 does not have to have exactly the same length as the second plate section 22, and that it does not matter as long as the difference in length between the two plate sections is not so big. In other words, it is an object of the invention to solve wasting of a material, i.e. a metal strap, and it is desirable to have smaller difference of distances between a right side edge of the carrier 20 and the ends of the first plate section 21 and the second plate section 22. For an example, the object of the present invention is fully attained if the difference of the distances is not greater than 15-25%.

The first plate section 21 and the second plate section 22 are joined at their bases 21A and 22A, which are joined to the carrier via a second base 23. Here, the first plate section 21 and the second plate section 22 are paired and are continuously provided to the carrier with certain intervals.

The unfinished terminal like this is bent with a tool. Once the unfinished terminal is intermittently fed to the tool position with the engaging hole 20A of the carrier 20, the first plate section 21 is made to a first contact blade 11 by making the first plate section pin-shaped and its end spherical through rounding process, and then inclining a lance 11E. At the same time, the second plate section 22 is made to be the second contact blade 12 which has a contact section 12B, by inclining process at a front end of section 22A which corresponds to a base 12A and by curving process at the end. At this point, the bases 21A and 22A are angled to L-shape as illustrated in FIG. 1(B) by bending process; thus, a terminal material with a carrier is obtained.

Then, the obtained terminal material with a carrier is disjoined at a position or single-dotted dash line P in FIG. 1(C), and then inserted to attach to a housing of a connector. Otherwise, after inserting into the housing, it can be cut at the position P so as to disjoin from the carrier.

As described above, since the unfinished terminal for the terminal material with the carrier has the first plate section 21 and the second plate section 22 which extend in the same direction with approximately the same length, scraps of the metal strap are so small that the yield of the material becomes high.

Second Embodiment

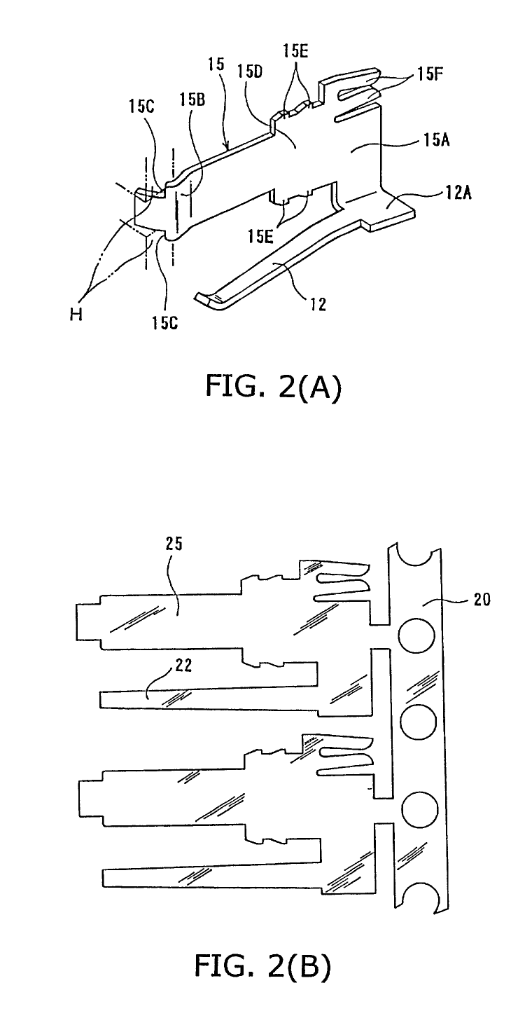

In FIG. 2(A), a second contact blade 12 is the same as in the first embodiment, but a first contact blade 15 is an elastic piece similar to the second contact blade 12. Since all the parts in this embodiment are the same as the one illustrated in FIG. 1 except the first contact blade 15, the same reference numbers are used for like parts as in FIG. 1, and the explanations are omitted.

The first contact blade 15 extends in the same direction as the second contact blade 12 from a base 15A which is perpendicular to a base 12A of the second contact blade 12, maintaining its flat surface. The first contact blade 15 has a fixing section 15D adjacent to the base 15A, and the fixing section 15D has engaging protrusions 15E. The fixing section 15D is a section to be inserted a corresponding slot (not illustrated) of a housing of a connector for retention, while the engaging protrusions 15E engage the housing to prevent sliding out from the housing.

The first contact blade 15 of the present invention has a contact section 15B which is made by bending process at a position near the end of the fixing section 15D, and the contact section 15B has a step-like engaging shoulder 15C at its front end. The contact section 15B is elastically deflected by a contact pressure from a terminal of its mating connector in perpendicular to a surface of the first contact blade 15, and at this time, the engaging shoulder 15C engages with its corresponding engaging section H of the housing so as to work as a stopper to prevent a greater deflection than the predetermined.

The first contact blade 15 has a connection section 15F at a side of its base 15A, which faces in opposite direction to the first contact blade 15. The connection section 15 shapes like a folk, shares the same surface as that of the base 15A, and has approximately the same width (in a direction perpendicular to the extending direction of the first contact blade 15 in the figure) as the base 15A.

According to the present invention, the unfinished terminal or terminal material with carrier before bending process is made by stamping a metal strap so as to be shaped as illustrated in FIG. 2(B).

Even in the unfinished terminal in FIG. 2(B), the first plate section 25 for the first contact blade 15 and the second plate section 22 for the second contact blade 12 have approximately the same length, so that a metal strap does not have to be wasted so much on stamping process.

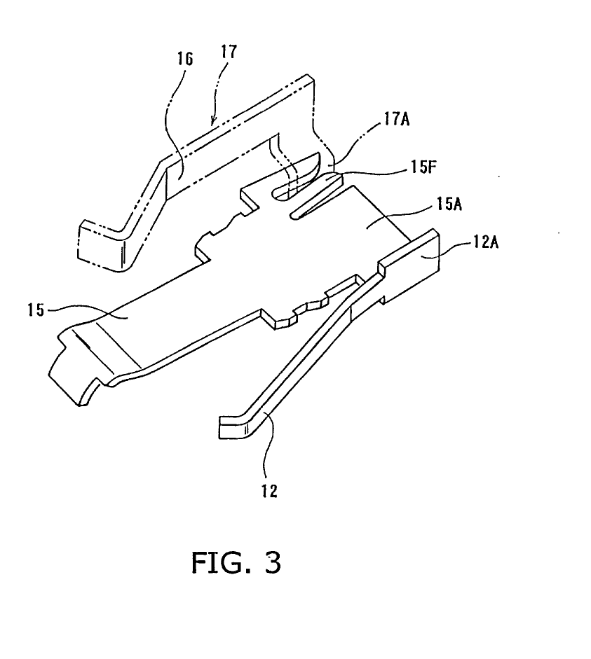

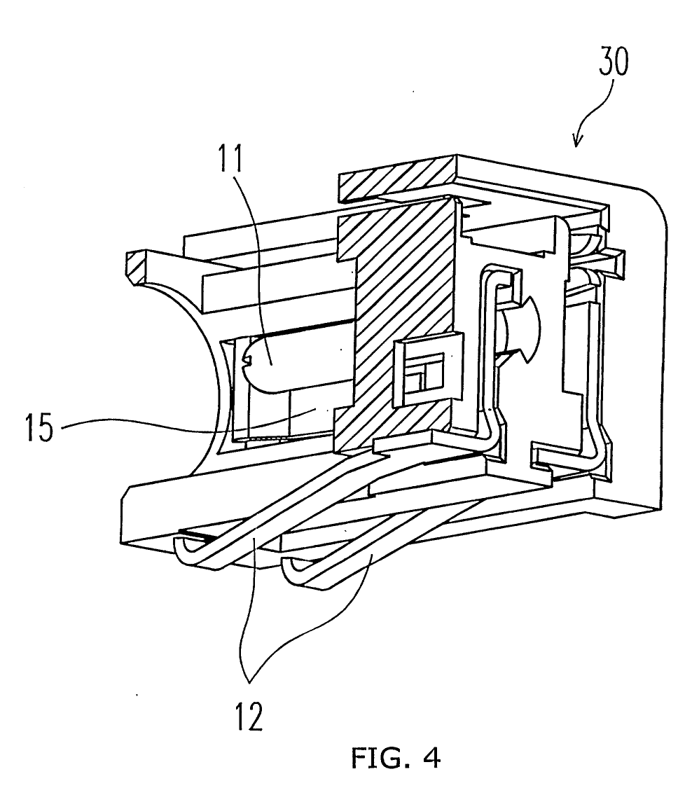

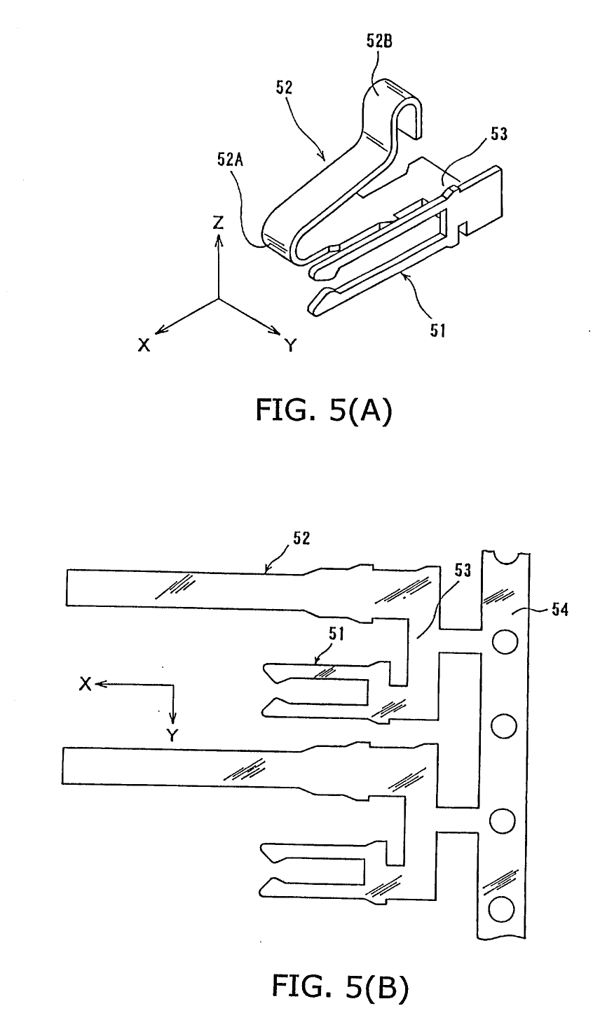

The terminal according to the present embodiment is used in a manner illustrated in FIG. 3.

FIG. 3 illustrates an example of use when the terminal with two contact blades 12 and 15 has an additional contact blade, a third contact blade. In this example, a terminal 17, which is also a third contact blade 16, is held at the housing, and the connection section 17A of the terminal 17 is connected at the folk-shaped connection section 15F. Accordingly, the number of contact blades of the terminal held in a housing can be increased.

Furthermore, the total number of the contact blades can be four by replacing the terminal 17 with one contact blade, which is illustrated in the figure, to the one with two contact blades. Accordingly, without making a complicated terminal, the terminal can be conveniently adjusted by selecting and connecting other terminal, such as the terminal 17, as necessary, so that it can match with the mating connector. At this time, if a plurality of contact blades have different length, a terminal with same length of contact blades can be made by grouping them together so that a desired contact mode can be attained while it provide a high yield, which is an object of the present invention. Furthermore, in this application, the contact blade is not limited to the form of an elastic piece, it can take other forms, like pin-shaped as illustrated in FIG. 1(A).

As has been described above, according to the present invention, the terminal has a plurality of contact blades which are joined and extend parallel each other with approximately the same length, so that the yield of the material in the stamping process is improved, that is, resources can be effectively used without wasting.

1. A terminal for an electrical connector which is made by stamping and then bending a metal sheet, comprising:
a plurality of contact blades which extend in a same direction when they are stamped, join each other at their bases so as to be one metal sheet, and have approximately a same length in an extending direction when they are stamped, wherein at least one of said contact blades is flexible in a direction perpendicular to an extending direction of other contact blades.

2. The terminal according to claim 1, wherein at least one of said contact blades is pin-shaped by rounding in said perpendicular direction.

3. The terminal according to claim 1, wherein said plurality of contact blades are flexible and at least one of said contact blades is flexible in a direction perpendicular to other contact blades.

4. The terminal according to claim 1, at least one of said contact blades has a connection section at its base to connect with another terminal.

5. A terminal material, comprising:
a plurality of said terminals according to claim 1; and
a strip-shaped carrier whereby said terminals are joined between their bases and an edge of said carrier with predetermined intervals such that said contact blades extend in a perpendicular direction to said edge of said carrier.

6. The electrical connector comprising:
a housing and
at least one terminal according to claim 1 inserted into said housing.
